(19) United States
(12) Patent Application Publication
(10) Pub. No.: US 2010/0146064 A1
(43) Pub. Date: Jun. 10, 2010

(54) SOURCE APPARATUS, SINK APPARATUS AND METHOD FOR SHARING INFORMATION THEREOF

(75) Inventors: Jiyeon SON, Daejeon-city (KR); Changseok BAE, Daejeon-city (KR); Jintae KIM, Daejeon-city (KR)

Correspondence Address: LADAS & PARRY LLP, 224 SOUTH MICHIGAN AVENUE, SUITE 1600, CHICAGO, IL, 60604, US

(73) Assignee: ELECTRONICS AND TELECOMMUNICATIONS RESEARCH INSTITUTE, Daejeon-city (KR)

(21) Appl. No.: 12/624,570

(22) Filed: Nov. 24, 2009

(30) Foreign Application Priority Data
Dec. 8, 2008 (KR) 10-2008-0124127
Sep. 28, 2009 (KR) 10-2009-0091577

(51) Int. Cl. G06F 15/16

(52) U.S. Cl. 709/206

(57) ABSTRACT

The present invention relates to platform architecture of smart devices according to information sharing, a sink apparatus, and a source apparatus, and more specifically, to platform architecture of smart devices capable of sharing information commonly used between daily living devices and thus, providing intelligent services, a sink apparatus, and a source apparatus. The source apparatus according to the embodiment of the present invention includes: a sensing unit that generates sensing data; a sharing information processing unit that generates sharable information based on the sensing data and converts the sharing information into sharing messages and transmits them to at least one sink apparatus by a wired and wireless network; and a source communication unit that notifies the sharing information from the sharing information processing unit to at least one sink apparatus through the wired or wireless network.

### RELATED APPLICATIONS

The present application claims priority to Korean Patent Application Serial Number 10-2008-0124127, filed on Dec. 8, 2008 and Korean Patent Application Serial Number 10-2009-0091577, filed on Sep. 28, 2009, the entirety of which are hereby incorporated by reference.

### BACKGROUND OF THE INVENTION

1. Field of the Invention

The present invention relates to platform architecture of smart devices according to information sharing, a sink apparatus, a source apparatus, and a method thereof, and more specifically, to platform architecture of smart devices according to information sharing that is capable of sharing information commonly used between daily living devices and thus, providing intelligent services, a sink apparatus, a source apparatus, and a method thereof.

2. Description of the Related Art

Generally, home appliances, as an example of daily living devices, are operated as a standalone scheme. The standalone scheme provides only non-adaptive and fixed functions regardless of users or environment. Currently, attempts to provide more intelligent services by providing a network connection function to these home appliances or attaching a sensor thereto have increased.

For example, home network appliances, which support a network connection according to a home network standard such as universal plug and play (UPnP), Jini, HAVI, etc., have been continuously launched as commercial products. An air conditioner that senses a change in indoor temperature and air flow to control wind volume and wind velocity, TV whose screen moves corresponding to the user motion, a robot cleaner that has an obstacle sensing sensor, a camera whose shutter is operated when a person input to the camera smiles, a washing machine that senses a concentration of a detergent in a fiber to automatically control a washing time and a rinsing frequency, etc., have been continuously launched as commercial products.

### SUMMARY OF THE INVENTION

Therefore, most daily living devices, which will be launched in the future according to the trend for the need of daily living devices connected by a network and intellectualized, will provide more intelligent services by including various sensors and anticipating the environment or user needs. In this case, several daily living devices can repeatedly solicit functions that can recognize the environment or the situations of the users. For example, user motion information can be commonly used to intellectualize devices such as a TV, an audio system, an air conditioner, a motor fan, a heater, etc.

However, it is necessary for individual devices to include sensors and have the repeated recognition functions for commonly solicited functions, thereby causing unnecessary waste of resources. Consequently, there occurs a problem in that product prices of daily living devices are correspondingly raised.

Therefore, the present invention proposes to solve the above problems. It is an object of the present invention to provide platform architecture of smart devices according to information sharing, which are capable of sharing information commonly used between daily living devices connected by a network and allowing individual devices to provide intelligent and customized services using the shared information by a sink apparatus, a source apparatus, and a method thereof.

A source apparatus according to the embodiment of the present invention includes: a sensing unit that generates sensing data; a sharing information processing unit that generates sharing information based on the sensing data, converts the sharing information into sharing messages and provides them to at least one sink apparatus through a wired or wireless network; and a source communication unit that notifies the sharing information from the sharing information processing unit to at least one sink apparatus through the wired or wireless network.

Preferably, the sharing information of the sharing information processing unit includes a sharing information list for solicitation of receiving the sharing information by at least one sink apparatus.

Preferably, the sharing information list of the sharing information processing unit includes at least one of a sharing information type, a code value for the corresponding sharing information, a description of the corresponding sharing information, and control parameters to be converted for the corresponding sharing information.

Preferably, the sharing information list of the sharing information processing unit further includes a registration list for the sink apparatus which is to receive the sharing messages.

Preferably, the sensing unit includes at least one sensor that senses users or ambient environments.

Preferably, the source apparatus further includes a collection and analysis unit that collects and analyzes the sensing data from the sensing unit; and a recognizer that extracts features based on the sensing data analyzed by the collection and analysis unit and recognizes specific patterns or specific information that are matched to the extracted features.

Preferably, the sharing information processing unit determines whether the specific information is information permitted to be opened based on the recognized results in the recognizer and if so, generates the sharing information.

Preferably, the source apparatus further includes a user interface, wherein the sharing information processing unit determines whether the specific information is information permitted to be opened based on the recognized results in the recognizer, by permission or non-permission of disclosure input to the user interface.

Preferably, the sharing information processing unit periodically provides the sharing information or provides it based on an event.

Preferably, the source communication unit includes a module that supports a wired or wireless communication protocol and transmits the sharing messages generated by the sharing information processing unit to at least one sink apparatus via the module.

Preferably, the source communication unit receives the messages input from at least one sink apparatus and transmits them to the sharing information processing unit.

A sink apparatus according to the embodiment of the present invention includes: a sink communication unit that receives sharing messages selectively including sharable information from at least one source apparatus through a wired or wireless network; a message processing unit that controls devices corresponding to the sharing information based on whether there is sharing information from the sharing messages received through the sink communication unit; and a device controller that controls devices corresponding to the sharing information from the message processing unit.

Preferably, the sharing information of the message processing unit includes a sharing information list for solicitation of receiving the sharing information by at least one source apparatus.

Preferably, the sharing information list of the message processing unit includes at least one of a sharing information type, a code value for the corresponding sharing information, a description of the corresponding sharing information, and control parameters to be converted for the corresponding sharing information.

Preferably, the sink apparatus further includes: a determining unit that determines whether the sharing information included in the sharing message can be used according to the solicitation of the message processing unit; and a parameter converter that converts the sharing information into the types and parameter values of the control parameters and transmits it to the device controller according to the request of the message processing unit.

Preferably, the message processing unit recognizes whether there is sharing information based on whether the sharing messages are control messages previously promised with at least one source apparatus.

Preferably, when the sharing messages are the control messages according to the recognition results of the message processing unit, the determining unit determines whether the corresponding sharing information included in the sharing messages can be used.

Preferably, when the sharing information is included in the sharing messages according to the recognition results of the message processing unit, the parameter converter converts the corresponding sharing information included in the sharing messages into the types and the parameter values of the control parameters and transmits it to the device controller.

Preferably, the device controller controls the corresponding devices according to the types and setting values of the parameters converted from the parameter converter and is dependently performed on the corresponding device.

Further, the sink apparatus further includes: a legacy device that is not controlled by the device controller; and an adaptor that supports connection with the legacy device.

A method for sharing information of a source apparatus according to the embodiment of the present invention includes: sensing that generates sensing data; sharing information process that generates sharable information based on the sensing data and converts the sharing information into sharing messages and provides them to at least one sink apparatus by a wired or wireless network; and source communicating that notifies the sharing information from the sharing information processing to at least one sink apparatus through the wired or wireless network.

Preferably, the sharing information of the sharing information processing includes a sharing information list for solicitation of receiving the sharing information by at least one sink apparatus.

A method for sharing information of a sink apparatus according to the embodiment of the present invention includes: sink communicating that receives sharing messages selectively including sharable information from at least one source apparatus through a wired or wireless network; message processing that controls devices corresponding to the corresponding sharing information according to whether there is sharing information of the sharing messages received through sink communicating; and device controlling that controls devices corresponding to the sharing information from the message processing.

Preferably, the sharing information of the message processing includes a sharing information list for solicitation of receiving the sharing information by at least one source apparatus.

Preferably, the sharing information list of the message processing includes at least one of a sharing information type, a code value for the corresponding sharing information, a description of the corresponding sharing information, and control parameters to be converted for the corresponding sharing information.

The present invention provides platform architecture sharing the information commonly used between daily living devices that are connected with each other by a network, such as user motion information, the distance information between devices, environmental information, etc., to effectively use resources and uses the sharing information without the individual devices including the separate sensors or the recognition apparatuses to provide intelligent and customized services.

### BRIEF DESCRIPTION OF THE DRAWINGS

FIG. 1 is a diagram showing a configuration of platform architecture of smart devices according to one embodiment of the present invention;

FIG. 2 is a diagram showing a configuration of sink apparatuses for one source apparatus;

FIG. 3 is a diagram schematically showing a configuration of the source apparatus of FIG. 1;

FIG. 4 is a diagram schematically showing a configuration of a sink apparatus of FIG. 1;

FIG. 5 is a diagram showing sharing message flow for information sharing of the source apparatus;

FIG. 6 is a diagram showing sharing message flow for information sharing of the sink apparatus;

FIG. 7 is a diagram showing an example of sharing information according to the present invention; and

FIGS. 8 and 9 are diagrams showing the sharing information according to one example of the sink apparatus.

### DETAILED DESCRIPTION OF THE PREFERRED EMBODIMENTS

Hereinafter, exemplary embodiments of the present invention will be described with reference to the accompanying drawings.

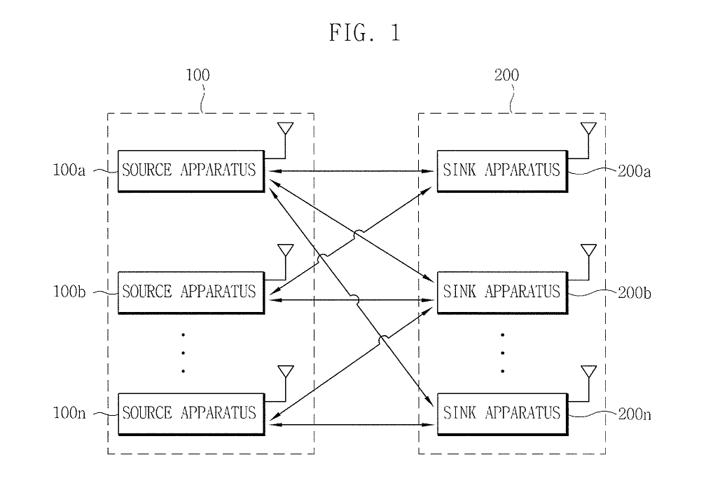

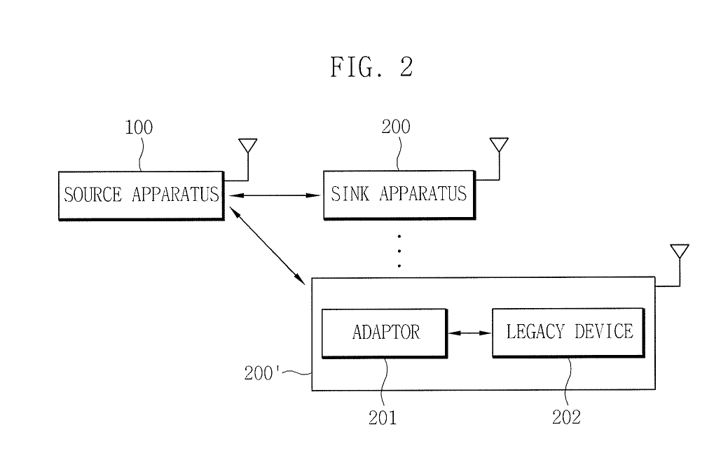

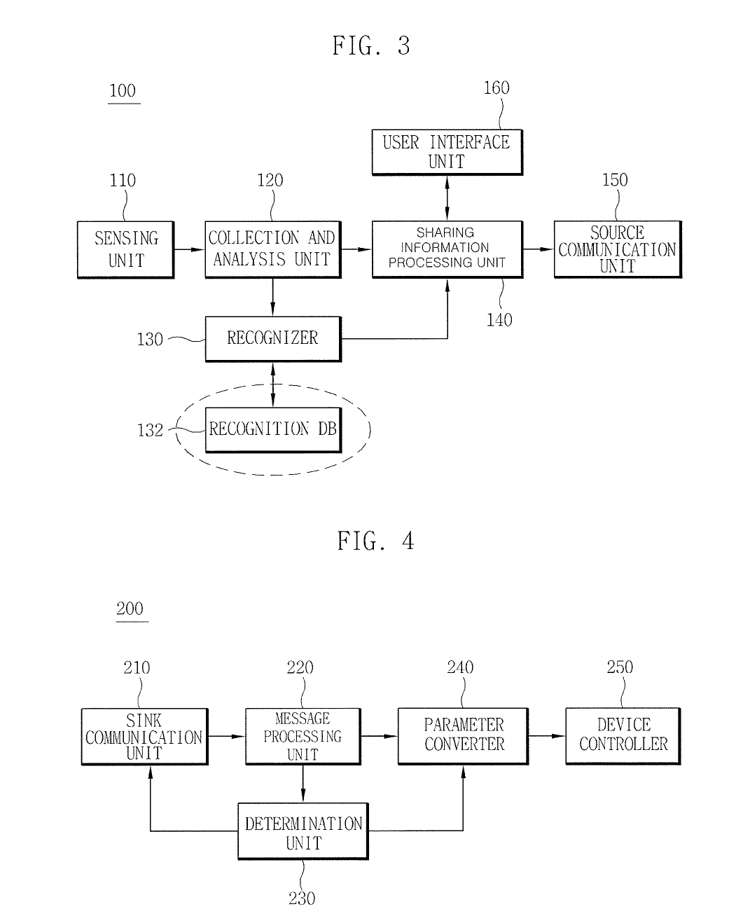

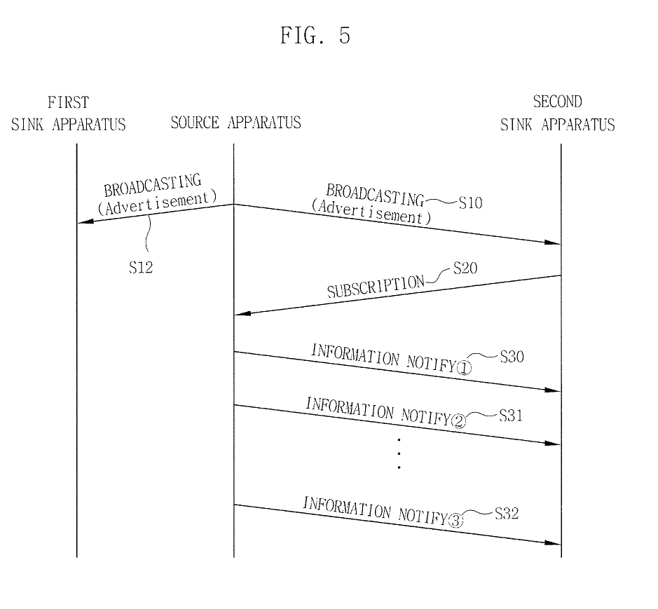

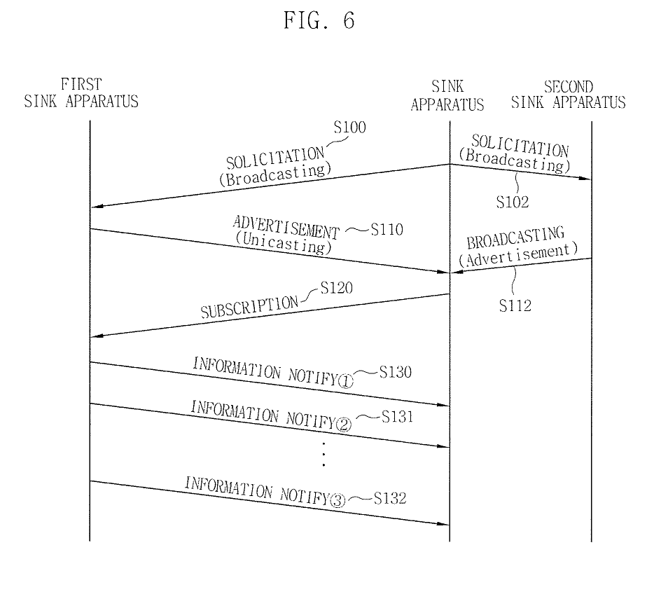

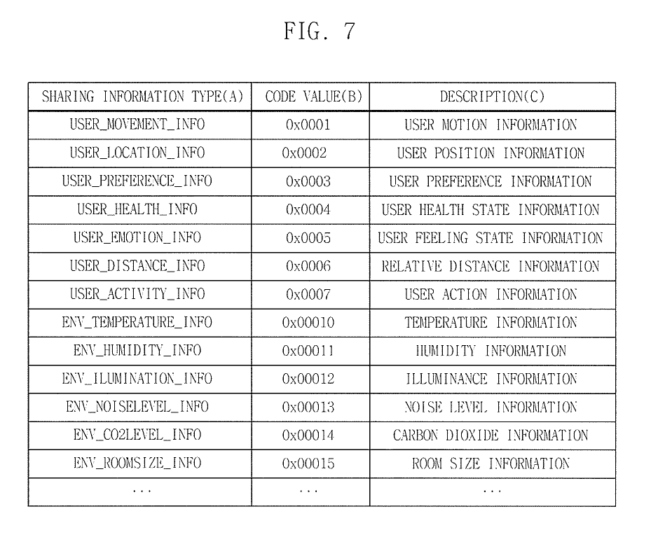

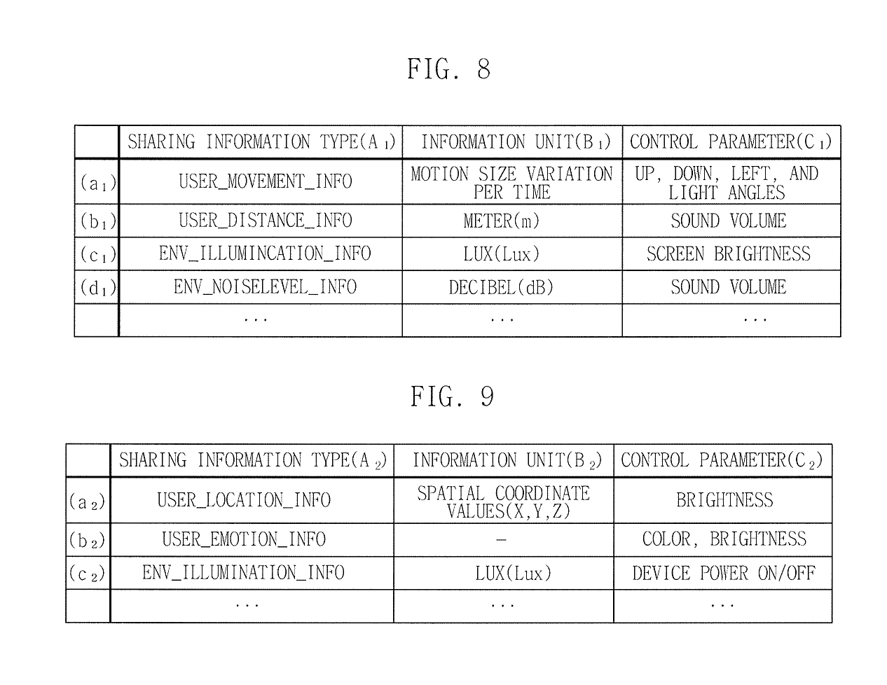

FIG. 1 is a diagram showing a configuration of platform architecture of smart devices according to one embodiment of the present invention, FIG. 2 is a diagram showing a configuration of sink apparatuses for one source apparatus, FIG. 3 is a diagram schematically showing a configuration of the source apparatus of FIG. 1, FIG. 4 is a diagram schematically showing a configuration of a sink apparatus of FIG. 1, FIG. 5 is a diagram showing the sharing message flow for information sharing of the source apparatus, FIG. 6 is a diagram showing the sharing message flow for information sharing of the sink apparatus, FIG. 7 is a diagram showing an example of sharing information according to the present invention, and FIGS. 8 and 9 are diagrams showing sharing information according to one example of the sink apparatus.

Referring to FIGS. 1 and 2, the platform architecture of smart devices according to the present invention is configured to include at least one source device 100 that provides commonly useable information to a plurality of devices (for example, home appliances) connected by a wired or wireless network and at least one sink apparatus 200 that provides intelligent services by using sharing information provided from the source apparatuses 100. In the present invention, the platform architecture of smart devices is configured to share information that can be commonly useable between daily living devices and thus, provide intelligent services.

In more detail, the source apparatus 100 configuring the platform architecture of smart devices according to the present invention is configured in plural, such as a first source device 100a, a second source device 100b, . . . , an n-th source device 100n, etc. The sink apparatus 200 is configured in plural, such as a first sink apparatus 200a, a second sink apparatus 200b, an n-th sink apparatus 200n, etc.

The present invention shares information commonly useable between the plurality of sink apparatuses 200 and the plurality of source apparatuses 100, such as user information, environmental information, etc., thereby making it possible to effectively use resources. For example, the present invention uses sharing information without including the same sensors or recognition devices for each device (for example, home appliances, etc.), thereby making it possible to provide intelligent and customized services. In other words, the present invention provides schemes sharing information commonly useable between daily living devices, such as user information or environmental information and uses the shared information, thereby making it possible to independently provide intelligent and customized services for each device.

The source apparatus 100 is an apparatus that generates information used to intellectualize the sink apparatuses 200, that is, the sharing information. The source apparatus 100 has a function that analyzes data input through sensors and extracts and recognizes features if necessary. The source apparatus 100 includes a function that notifies the sharing information to the plurality of devices through the network. An actual example of the source apparatus 100 may include an apparatus for tracking a user motion, an apparatus for recognizing a user position, an apparatus for sensing environmental information such as temperature, humidity, etc., an apparatus for estimating a relative distance, an apparatus for measuring a user health state, an apparatus for recognizing user feeling, etc., but include all apparatuses including specific recognition functions.

The sink apparatus 200 receives the shared information from the source apparatus 100 and determines whether it can use the information and includes a function that converts the information into control parameters for driving a device controlling control unit and adaptively customizes the converted parameters by the device controlling unit. An actual example of the sink apparatus 200 may include daily living devices, such as a TV, an air conditioner, a refrigerator, a washing machine, a lamp, an audio device, a cleaner, etc., all of which can provide intelligent services.

In the present invention, the sink apparatus 200 should previously define a ‘sharing information list’ useable to intellectualize the corresponding devices, wherein the ‘sharing information list’ may include the types and conversion equations, etc., of the control parameters that convert a sharing information type and individual information.

Referring to FIG. 2, it is preferable that the sink apparatus 200 further includes a legacy device that is not controlled by the following device controller and an adaptor that supports the connection with the legacy device. The sink apparatus 200, which is configured to include a legacy device 202 and an adaptor 201, is to enable the existing legacy devices 212, which do not support the platform architecture of the present invention, to use the sharing information in order to provide intelligent and customized services. For example, the sink apparatus is configured by attaching the adaptor 201 to a front end of the legacy device 202. Instead of the legacy device 212, the adaptor 201 can perform all functions that should be performed in the sink apparatus 200 and may have additional functions that directly drive the legacy device 212.

Herein, at least one source apparatus 100 and at least one sink apparatus 200 are connected with each other by a wired or wireless network and require a series of a standard control message exchanging procedure for sharing information. Of course, the function of the source apparatus 100 and the sink apparatus 200 may be implemented in a single device.

Referring to FIG. 3, the source apparatus 100 according to the present invention is configured to include a sensing unit 110 that generates sensing data, a sharing information processing unit 140 that generates sharable information based on the sensing data and converts the sharing information into sharing messages and provides them to at least one sink apparatus 200 by a wired and wireless network; and a source communication unit 150 that notifies the sharing information from the sharing information processing unit 140 to at least one sink apparatus 200 through the wired or wireless network.

In addition, it is preferable that the source apparatus 100 according to the present invention further includes a collection and analysis unit 120, a recognizer 130, and a user interface unit 160.

Herein, the sharing information of the sharing information processing unit 140 includes a sharing information list, as described above. Therefore, the sharing information processing unit 140 should previously define a ‘sharing information list’ useable to intellectualize the corresponding devices, wherein the ‘sharing information list’ may include the types and conversion equations, etc., of the control parameters that convert a sharing information type and individual information.

The sensing unit 110 includes at least one sensor to sense users or ambient environments. The sensor data input through the sensors are analyzed through the collection and analysis unit 120.

The recognizer 130 provides a function that extracts features and recognizes specific patterns or specific information, based on the data analyzed by the analysis unit 120. In order to more accurately and reliably perform the recognition function, it may include a separate recognition database (DB) 132. On the other hand, the recognizer 130 may be omitted according to the type of sharing information provided from the source apparatus 100.

It is determined whether the results obtained via the recognizer 130 or the collection and analysis unit 120 are information permitted to be opened by the sharing information processing unit 140 and if so, the sharing messages are generated. At this time, a reference about permission or non-permission of disclosure may be input through the user interface unit 160. In other words, the sharing information processing unit 140 determines whether the results are information permitted to be opened based on the recognized results in the recognizer 130, according to the permission or non-permission of disclosure that is input to the user interface unit 160.

Of course, the recognizer 130 may provide all the information recognized as default in an opened form. In other words, the sharing information processing unit 140 determines whether the results are information permitted to be opened based on the results recognized in the recognizer 140 and if so, generates the sharing information.

Herein, the sharing information can be periodically generated or generated based on an event. The sharing information processing unit 140 processes the sharing messages according to the standardized message exchanging protocol between the source apparatus 100 and the sink apparatus 200 in order to share information. An example of the message exchange may include a solicitation message that solicits contents of the sharing information provided from the source apparatus 100 and a subscription message that solicits receiving the corresponding information whenever the sharing information is generated.

The source communication unit 150 includes a module that supports a wired or wireless communication protocol to transmit the sharing messages generated by the sharing information processing unit 140 to at least one sink apparatus 200. The source communication unit 150 also receives the sharing messages input from at least one sink apparatus 200 to perform a function that hands the sharing messages to the sharing information processing unit 140.

The user interface unit 160, which is a unit setting control values of the source apparatus 100, may include a setting function, such as sensing period and information disclosure reference, various parameter values for data analysis and recognition, information generation period, etc.

Referring to FIG. 4, the sink apparatus 200 according to the embodiment of the present invention is configured to include a sink communication unit 210 that receives sharing messages selectively including sharable information from at least one source apparatus 100 through a wired or wireless network; a message processing unit 220 that controls devices corresponding to the corresponding sharing information according to whether there is sharing information of the sharing messages received through the sink communication unit 210; and a device controller 250 that controls devices corresponding to the sharing information from the message processing unit 220.

In addition, it is preferable that the sink apparatus 200 according to the present invention includes a determining unit 230 and a parameter converter 240.

The sink communication unit 210 includes the module that supports the wired or wireless communication protocol to receive the sharing information from at least one source apparatus 100.

The message processing unit 220 analyzes whether the received message is a previously promised control message between the source apparatus 100 and the sink apparatus 200 or is the sharing information received from the specific source apparatus 100, in order to share information. In other words, the message processing unit 220 can recognize whether there is sharing information based on whether the sharing message is the control message previously promised with at least one source device 100.

Herein, when the sharing message is the control message for sharing information according to the determination result, the message processing unit 220 determines whether the corresponding information is included in the ‘sharing information list’ through the determination unit 230. The ‘sharing information list’ is previously defined by a manufacturer at the timing when the sink apparatus 200 is launched as a product. The ‘sharing information list’ is a list of the sharing information usable in allowing the corresponding sink apparatus to provide the intelligent or customized services. The message processing unit 220 transmits messages to the source apparatus 100 side that transmits the corresponding information when the corresponding information is included in the ‘sharing information list’.

Also, the message processing unit 220 performs a function that converts the sharing information into the types and parameter values of the control parameter by the parameter converter 240 when the analyzed information is the sharing information and adaptively controls them. The detailed conversion equations or methods for the parameter conversion can be independently defined by manufacturers of the individual sink apparatus 200.

The device controller 250 drives the control unit that controls the device of the sink apparatus 200 according to the types and setting values of the foregoing converted parameters. The methods for driving the control unit are dependently performed on the individual sink apparatus 200.

Hereinafter, a sharing message flow for sharing initial information when a new source apparatus 100 is driven will be described with reference to FIG. 5.

First, when the source apparatus 100 according to the present invention is first driven, it broadcasts the sharing information generated by the source apparatus 100, that is, an advertisement message including contents associated with the sharing information type to the plurality of sink apparatuses 200 (S10 and S12).

Next, a first sink apparatus 200a and a second sink apparatus 200b, which receive the advertisement message, determine whether the sharing information type in the advertisement message is included in the ‘sharing information list’ thereof and if so, transmits the subscription solicitation message to the corresponding source device (S20).

Then, the source apparatus 100 receives the subscription solicitation message from at least one sink apparatus 200 and includes addresses of the sink apparatuses 200 in its own registration list. Thereafter, whenever the sharing information is generated, the sharing Information Notify is transmitted to the sink apparatuses 200 that are included in the registration list (S30, S31, and S32).

Hereinafter, the sharing message flow for sharing initial information when the sink apparatus 200 is driven will be described with reference to FIG. 6.

First, the sink apparatus 200 according to the present invention is first driven, it notifies its own existence and broadcasts the solicitation message that solicits the contents of the sharing information to the source apparatuses 100 (S100 and S102).

Next, the first source apparatus 100a and the second source apparatus 100b, which receive the solicitation messages, transmits the sharing information provided by the first and second source apparatuses 100a and 100b, that is, the advertisement message including the contents associated with the sharing information type to the sink apparatus 200 (S110 and S112).

Then, the sink apparatus 200 analyzes the advertisement messages received from at least one source apparatus 100 to compare and determine the sharing information type with its own sharing information list.

Therefore, the sink apparatus 200 transmits the subscription request message to the second source apparatus 100b that generates the adaptable sharing information (S120).

Next, the second source apparatus 100b receives the subscription solicitation message and adds the corresponding sink device to the registration list and transmits the following generated sharing information to the registered sink devices (S130, 5131, and S132).

Referring to FIG. 7, the sharing information list between the source apparatus and the sink apparatus 200 may be configured to include the sharing information type (A), the code value (B) for the sharing information type, the description (C) of the sharing information, etc.

Therefore, the present invention shares information commonly useable between the plurality of sink apparatuses 200 and the plurality of source apparatuses 100, such as user information, environmental information, etc., thereby effectively using resources. For example, the apparatus for tracking user motion understands the user motion to transmit the sharing message including the sharing information type ‘USER_MOVEMENT_INFO’ and the sharing message including the corresponding code value ‘0x001’ to daily living devices, such as a TV, an air conditioner, a refrigerator, a washing machine, a lamp, an audio device, a cleaner, etc., all of which can provide intelligent services.

Referring to FIG. 8, a case where the sink apparatus 200 is a smart TV device will be described as one example. Where, ‘A’ represents a sharing information type, ‘B1’ represents an information unit of the sharing information type of ‘A1’, and ‘C1’ represents the types of control parameters to be converted for the information unit of ‘B1’.

First, the sharing information type ‘A1’ is a part of the adaptable sharing information type in order to intellectualize the TV among types shown in FIG. 7.

Like (a1), the information unit of a ‘USER_MOVEMENT_INFO’ type is motion size variations per time and the control parameters of the information is up, down, left, and right angles of the TV. In other words, if the TV, which is the sink apparatus 200, receives the sharing information on (a1) from the source apparatus 100, the up, down, left, and right angles of the TV are controlled according to the sharing information.

Like (b1), the information unit of a ‘DISTANCE_INFO’ type is meter (m) and the control parameter of the information is sound volume. In other words, if TV, which is the sink apparatus 200, receives the sharing information on (b1) from the source apparatus 100, the sound volume is controlled according to the sharing information.

Like (c1), the information unit of an ‘ILLUMINATION_INFO’ type is lux and the control parameter of the information is screen brightness. In other words, if the TV, which is the sink apparatus 200, receives the sharing information on (b1) from the source apparatus 100, the screen brightness are controlled according to the sharing information.

Like (d1), the information unit of an ‘ENV_NOISENESS_INFO’ type is decibel (dB) and the control parameter of the information is sound volume. In other words, if the TV, which is the sink apparatus 200, receives the sharing information on (b1) from the source apparatus 100, the sound volume is controlled according to the sharing information.

Referring to FIG. 9, a case where the sink apparatus 200 is a smart lamp device will be described as one example.

Where, ‘A2’ represents a sharing information type, ‘B2’ represents an information unit of the sharing information type of ‘A2’, and ‘C2’ represents the types of control parameters to be converted for the information unit of ‘B2’.

The sharing information type ‘A2’ is a part of the adaptable sharing information type in order to intellectualize the lamp device among types shown in FIG. 7.

Like (a2), the information unit of a ‘USER_LOCATION_INFO’ type is spatial coordinate values (X, Y, and Z) and the control parameter of the information is brightness. In other words, if the smart lamp device, which is the sink apparatus 200, receives the sharing information on (a2) from the source apparatus 100, the brightness is controlled according to the sharing information.

Like (b2), the information unit of a ‘USER_EMOTION_INFO’ type may be classified into pleasure, angry, depression, sadness, fear, etc., and the control parameter of the information is the color or brightness of the lamp. In other words, if the smart lamp device, which is the sink apparatus 200, receives the sharing information on (b2) from the source apparatus 100, the color or brightness of the lamp is controlled according to the sharing information.

Like (c2), the information unit of the ‘ILLUMINATION_INFO’ type is lux and the control parameter of the information is device power on/off. In other words, if the smart lamp device, which is the sink apparatus 200, receives the sharing information on (c2) from the source apparatus 100, the device power on/off is controlled according to the sharing information.

As described above, the present invention provides the platform architecture sharing the information commonly used between daily living devices that are connected with each other by the network, such as the user motion information, the distance information between devices, the environmental information, etc., to effectively use resources and use the sharing information without the individual devices including the separate sensors or the recognition apparatuses to provide the intelligent and customized services.

The present invention is not limited to the foregoing embodiments, but the embodiments may be configured by selectively combining all the embodiments or some of the embodiments so that various modifications can be made.

What is claimed is:

1. A source apparatus, comprising:
a sensing unit that generates sensing data;
a sharing information processing unit that generates sharing information based on the sensing data, converts the sharing information into sharing messages and provides them to at least one sink apparatus through a wired or wireless network; and
a source communication unit that notifies the sharing information from the sharing information processing unit to at least one sink apparatus through the wired or wireless network.

2. The source apparatus according to claim 1, wherein the sharing information of the sharing information processing unit includes a sharing information list for solicitation of receiving the sharing information by at least one sink apparatus.

3. The source apparatus according to claim 2, wherein the sharing information list of the sharing information processing unit includes at least one of a sharing information type, a code value for the corresponding sharing information, a description of the corresponding sharing information, and control parameters to be converted for the corresponding sharing information.

4. The source apparatus according to claim 3, wherein the sharing information list of the sharing information processing unit further includes a registration list for the sink apparatus which is to receive the sharing messages.

5. The source apparatus according to claim 1, further comprising:
a collection and analysis unit that collects and analyzes the sensing data from the sensing unit; and
a recognizer that extracts features based on the sensing data analyzed by the collection and analysis unit and recognizes specific patterns or specific information that are matched to the extracted features.

6. The source apparatus according to claim 5, wherein the sharing information processing unit determines whether the specific information is information permitted to be opened based on the recognized results in the recognizer and if so, generates the sharing information.

7. The source apparatus according to claim 6, further comprising:
a user interface
wherein the sharing information processing unit determines whether the specific information is information permitted to be opened based on the recognized results in the recognizer, according to permission or non-permission of disclosure that is input to the user interface.

8. A sink apparatus, comprising:
a sink communication unit that receives sharing messages selectively including sharing information from at least one source apparatus through a wired or wireless network;
a message processing unit that controls devices corresponding to the corresponding sharing information according to whether there is the sharing information of the sharing messages received through the sink communication unit; and
a device controller that controls devices corresponding to the sharing information from the message processing unit.

9. The sink apparatus according to claim 8, wherein the sharing information of the message processing unit includes a sharing information list for solicitation of receiving the sharing information by at least one source apparatus.

10. The sink apparatus according to claim 9, wherein the sharing information list of the message processing unit includes at least one of a sharing information type, a code value for the corresponding sharing information, a description of the corresponding sharing information, and control parameters to be converted for the corresponding sharing information.

11. The sink apparatus according to claim 8, further comprising:
a determining unit that determines whether the sharing information included in the sharing message can be used according to the solicitation of the message processing unit; and
a parameter converter that converts the sharing information into the types and parameter values of the control parameters and transmits it to the device controller according to the request of the message processing unit.

12. The sink apparatus according to claim 11, wherein the message processing unit recognizes whether there is the sharing information based on whether the sharing messages are control messages previously promised with at least one source apparatus.

13. The sink apparatus according to claim 12, wherein when the sharing messages are the control messages, the determining unit determines whether the corresponding sharing information included in the sharing messages can be used.

14. The sink apparatus according to claim 12, wherein when the sharing information is included in the sharing messages according to the recognition results of the message processing unit, the parameter converter converts the corresponding sharing information included in the sharing messages into the types and parameter values of the control parameters and transmits it to the device controller.

15. The sink apparatus according to claims 8, further comprising:
a legacy device that is not controlled by the device controller; and
an adaptor that supports connection with the legacy device.

16. A method for sharing information of a source apparatus, comprising:
generating sensing data;
processing sharing information by generating sharing information based on the sensing data, converting the sharing information into sharing messages and providing them to at least one sink apparatus through a wired or wireless network; and
source communicating that notifies the sharing information from the sharing information processing to at least one sink apparatus through the wired or wireless network.

17. The method for sharing information of a source apparatus according to claim 16, wherein the sharing information of the sharing information processing includes a sharing information list for solicitation of receiving the sharing information by at least one sink apparatus.

18. A method for sharing information of a sink apparatus, comprising:
sink communicating that receives sharing messages selectively including sharing information from at least one source apparatus through a wired or wireless network;
message processing that controls devices corresponding to the corresponding sharing information according to whether there is the sharing information of the sharing messages received through the sink communicating; and
device controlling that controls devices corresponding to the sharing information from the message processing.

19. The method for sharing information of a sink apparatus according to claim 18, wherein the sharing information of the message processing includes a sharing information list for solicitation of receiving the sharing information by at least one source apparatus.

20. The method for sharing information of a sink apparatus according to claim 19, wherein the sharing information list of the message processing includes at least one of a sharing information type, a code value for the corresponding sharing information, a description of the corresponding sharing information, and control parameters to be converted for the corresponding sharing information.
